(19) United States
(12) Patent Application Publication
(10) Pub. No.: US 2019/0292955 A1
(43) Pub. Date: Sep. 26, 2019

(54) METHOD OF PROVIDING A LEAK FREE ACOUSTIC VOLUME FOR A VEHICLE FRAME MEMBER

(71) Applicant: Faurecia Emissions Control Technologies, USA, LLC, Columbus, IN (US)

(72) Inventors: Thorsten Keesser, Augsburg (DE); James Egan, Greenwood, IN (US)

(21) Appl. No.: 15/926,231

(22) Filed: Mar. 20, 2018

(51) Int. Cl. F01N 1/04; F01N 1/02; F01N 1/24

(52) U.S. Cl. CPC F01N 1/04; B60K 13/04; F01N 1/24; F01N 1/023

(57) ABSTRACT

A method of forming an acoustic volume in a vehicle component includes providing a vehicle frame member that includes a hollow cavity, forming an internal shell that is completely sealed and which includes at least one connection point, and locating the internal shell within the hollow cavity. At least one exhaust system component is connected to the internal shell at the connection point to provide at least one acoustic volume.

### BACKGROUND OF THE INVENTION

An exhaust system conducts hot exhaust gases generated by an engine through various exhaust components to reduce emissions, improve fuel economy, and control noise. Short exhaust systems, such as those encountered with hybrid vehicles or rear engine vehicles for example, often have insufficient volume and/or length to achieve a desired tailpipe noise level in combination with acceptable back pressure levels. Further, as gasoline particulate filter (GPF) technology emerges into the market, corresponding increases in exhaust system back pressure will need to be offset in order to avoid adverse effects on fuel economy or performance.

In addition to addressing issues raised by the introduction of GPF technology, other emerging powertrain technologies are requiring the industry to provide even more stringent noise reduction. The frequencies that need to be attenuated are being pushed to lower and lower frequencies not previously having to have been addressed. One traditional solution to attenuate such frequencies is to provide more internal volume; however, due to tight packaging constraints, the area required for such volume is not available. Another solution to attenuate these lower frequencies is to use valves; however, valves drive a higher back pressure at lower revolutions-per-minute, which is not desirable. As such, there is a need for unique acoustic solutions that are more efficient from a volume perspective and have less impact from a back pressure aspect.

### SUMMARY OF THE INVENTION

In one exemplary embodiment, a method of forming an acoustic volume in a vehicle component includes providing a vehicle frame member that includes a hollow cavity, forming an internal shell that is completely sealed and which includes at least one connection point, and locating the internal shell within the hollow cavity. At least one exhaust system component is connected to the internal shell at the connection point to provide at least one acoustic volume.

In another exemplary embodiment, a vehicle exhaust system includes a first component that receives exhaust gas output from an engine, a first exhaust assembly fluidly coupled to the first component to define a hot end of a vehicle exhaust system, and a second exhaust assembly fluidly coupled to the first exhaust assembly to define a cold end of the vehicle exhaust system, wherein an exhaust gas temperature at the hot end is higher than at the cold end. A frame member includes a hollow cavity. An internal shell is completely sealed and includes at least one connection point, wherein the internal shell is received within the hollow cavity to provide an internal acoustic volume. A neck connects to the connection point of the internal shell such that the internal acoustic volume is in parallel to the hot end of the vehicle exhaust system.

In a further embodiment of the above, the method includes forming the internal shell by blow molding.

In a further embodiment of any of the above, the internal shell is formed from a plastic or composite material.

In a further embodiment of any of the above, the frame member comprises a support beam configured to at least partially support the engine and that connects to at least one additional vehicle frame member.

In a further embodiment of any of the above, the frame member comprises at least first and second outer shells that enclose the hollow cavity.

In a further embodiment of any of the above, the first and second outer shells comprise metal stampings.

In a further embodiment of any of the above, the first component comprises an exhaust manifold or turbocharger, and wherein the first exhaust assembly includes one or more of a catalytic converter, diesel oxidation catalyst, or a particulate filter, and wherein the second exhaust assembly comprises one or more mufflers coupled to one or more tailpipes.

These and other features of this application will be best understood from the following specification and drawings, the following of which is a brief description.

### BRIEF DESCRIPTION OF THE DRAWINGS

FIG. 1 schematically illustrates a vehicle exhaust system and shows standing pressure waves generated by the system.

FIG. 2 shows a schematic representation of one example of a vehicle frame member that includes an internal acoustic volume that is connected to a hot end component of the system of FIG. 1.

FIG. 3 is a schematic representation of a catalytic converter coupled to an internal acoustic volume of the frame member of FIG. 2.

FIG. 4 shows another example embodiment of a frame member.

FIG. 5A is a perspective view of an internal shell that is to be incorporated into the vehicle frame member.

FIG. 5B is the internal shell of FIG. 5A located within the vehicle frame member.

### DETAILED DESCRIPTION

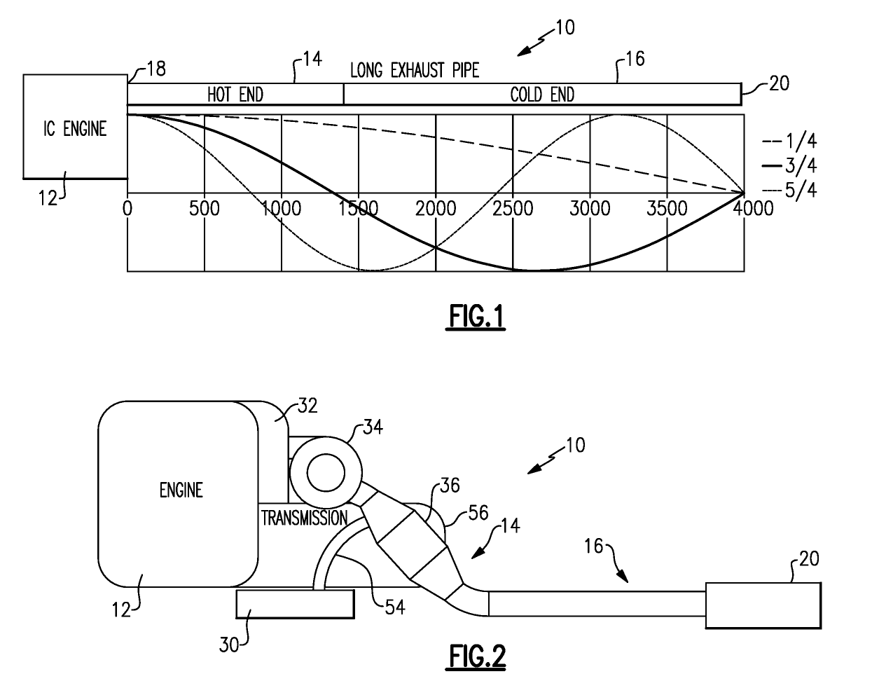

FIG. 1 shows a schematic representation of a vehicle exhaust system 10 as a long pipe that conducts hot exhaust gases generated by an engine 12 through various exhaust components to reduce emission and control noise as known. The various exhaust components can include one or more of the following: pipes, filters, valves, catalysts, mufflers etc. The exhaust system 10 includes a hot end 14 that is located immediately downstream of the engine 12 and a cold end 16 that is downstream of the hot end 14. The exhaust gas temperature at the hot end 14 is higher on average than at the cold end 16. The long pipe is considered closed at an engine end 18 and open at an opposite end 20 where, after passing though the various exhaust components, the engine exhaust gas exits the exhaust system 10 to atmosphere.

Exhaust components at the hot end 14 can include, for example, exhaust gas treatment elements such as a diesel oxidation catalyst (DOC), a diesel particulate filter (DPF), a gasoline particulate filter (GPF), a three-way catalyst (TWC), and a selective catalytic reduction (SCR) catalyst that are used to remove contaminants from the exhaust gas as known. Exhaust gases pass through these components and enter the cold end 16 where the exhaust gas exits the system 10 via a tailpipe. The cold end 16 can include components such as mufflers, valves, and one or more tailpipes, for example. The described exhaust components can be mounted in various different configurations and combinations dependent upon vehicle application and available packaging space.

As discussed above, FIG. 1 shows the exhaust system schematically illustrated as a long pipe that is closed at the engine end 18 and open at the opposite end 20 to atmosphere. Acoustic waves will travel from their source, which is the engine 12, down the pipe and then the exit to atmosphere. When the acoustic wave encounters a boundary of some form, e.g. an impedance change, then some fraction of the wave will be reflected back the way it came and the remaining fraction will continue. In the case of a closed-open pipe such as shown in FIG. 1, this reflection occurs at the exit of the pipe. The reflected wave interferes with the incident wave and at certain frequencies, which are a function of the length of the pipe, constructively interfere to increase the level of the wave and also to make the wave appear stationary. Such waves are called standing waves and in the case of a closed-open pipe the frequencies of such waves may be calculated with the equation below.

Fn=(nc)/(4L) where:

fn=resonant frequency of standing wave n (Hz)

n=ordinal number of standing wave

c=speed of sound (m/s)

L=length of closed-open pipe (m)

The chart of FIG. 1 shows the first three standing pressure waves for a closed-open pipe of 4 meters in length. In this example, the resonances occur at 22, 65, and 108 Hz. As shown, for each standing wave the pressure is a maximum (anti-node) at the closed engine end 18 and a minimum (node) at the open end 20 to atmosphere. The ideal place for a Helmholtz resonator is at a pressure anti-node. As such, the best position for a resonator is at the engine outlet; however, Helmholtz resonators are not traditionally used in the hot end 14 of exhaust systems 10. The subject invention provides a method for forming a Helmholtz resonator in the hot end 14 to provide improved acoustic benefits over the same resonator as placed in the cold end 16 as the subject resonator is closer to the anti-node for all system acoustic resonances.

It has been shown through testing and simulations that a Helmholtz Resonator, such as an acoustic volume of the order of 2 to 4 liters (L) connected in parallel with the exhaust flow via a neck pipe for example, that is positioned in the hot end 14 between a turbo outlet and a converter, or between converter after-treatment elements, provides an acoustic benefit about twice that of a similar amount of volume applied in the cold end 16 (downstream of the after-treatment) with no impact on back pressure. From a tailpipe noise perspective, positioning the Helmholtz resonator as close as possible to the engine 12 provides the best acoustic performance

The subject invention proposes a method for forming one or more Helmholtz Resonators so that they can be packaged at one of various locations in the hot end 14 of the system 10. The difficulty with this proposal; however, is that there is very little packaging space available at the hot end 14 of the system. In order to overcome this packaging issue, it is proposed to use an already existing vehicle component as the Helmholtz volume. One example of such a volume is found in application Ser. No. 15/874,288, which was filed on Jan. 18, 2018 and which is assigned to the assignee of the present application and incorporated herein. FIG. 2 shows this example of the exhaust system 10 that utilizes a vehicle frame member 30 to provide an acoustic volume.

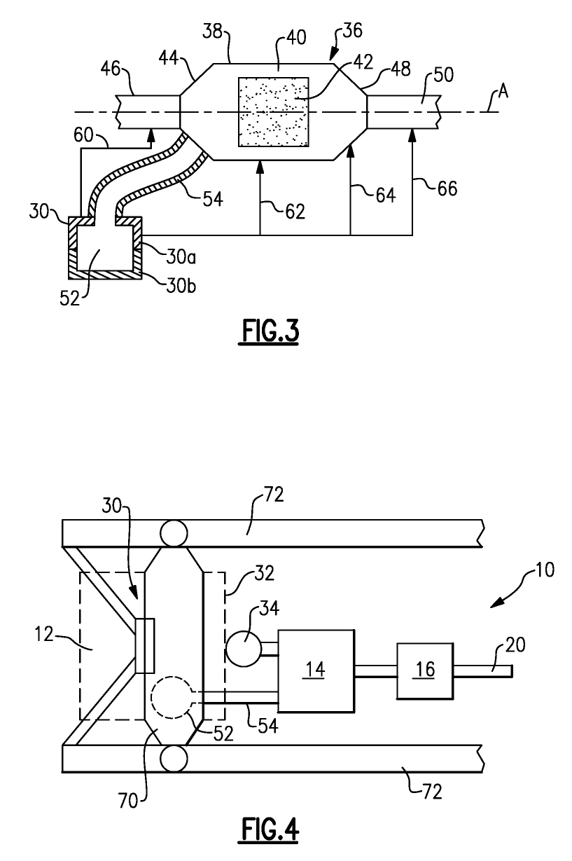

As shown in FIGS. 2-3, the engine 12 has an exhaust manifold 32 that directs hot engine exhaust gases into the vehicle exhaust system 10. An optional turbocharger 34 may be positioned between the manifold 32 and the exhaust system 10. In this example, the hot end 14 includes a hot end component 36, such as a catalytic converter for example, which includes a component housing 38 that defines an internal cavity 40. At least one exhaust gas treatment element 42 is positioned within the internal cavity 40. An inlet cone 44 directs flow into the exhaust gas treatment element 42. The inlet cone 44 receives hot engine exhaust gases from an inlet pipe 46. An outlet cone 48 directs treated exhaust gas flow exiting the exhaust gas treatment element 42 into an outlet pipe 50. In this example, the component housing 38 defines a center axis A and the inlet cone 44, exhaust gas treatment element 42, and outlet cone 48 are coaxial with the center axis A.

The vehicle frame member 30 provides an internal acoustic volume 52 that is enclosed within the frame member 30. The internal acoustic volume 52 is fluidly coupled in parallel to the hot end 14 of the exhaust system 10 with a connecting pipe or neck 54. In one example, the vehicle frame member 30 comprises an engine sub-frame that extends underneath the engine 12 to support the engine 12 and possibly a vehicle transmission 56 or gearbox. The engine 12 and transmission 56 are schematically shown in FIG. 2, and it should be understood that any type of engine 12 and/or transmission 56 can be used with the subject exhaust system 10.

In one example shown in FIG. 3, the frame member 30 is comprised of a least two sub-components or rigid shells 30a, 30b of stamped metal that enclose a hollow cavity. In another example, the frame member 30 can be formed via hydroforming, for example, to provide a single-piece outer housing structure with a hollow cavity. In each example, the hollow cavity is completely sealed and is airtight to provide the internal acoustic volume 52. This volume 52 is a parallel volume to the hot end 14 of the exhaust system 10 and is connected to the system downstream of the manifold 32 and/or turbocharger 34 with the pipe or neck 54. In one example, the pipe or neck 54 comprises a body that has at least one partially flexible portion to accommodate movement of the engine 12 and exhaust system relative to the frame member 30.

In the example shown in FIGS. 2-3, the neck 54 is positioned to connect the internal acoustic volume 52 to the internal cavity 40 via the inlet cone 44. Optionally, or in addition to, the connection point of the neck 54 to the hot end 14 could be immediately upstream of the inlet cone 44 (see 60), at a center portion of the housing 38 (see 62), at the outlet cone 48 (see 64), or immediately downstream of the outlet cone 48 (see 66).

In each of these different configurations, the internal acoustic volume 52 is sealed and in parallel with the exhaust flow through the exhaust system such that there is no net flow in the Helmholtz resonator. Hot engine exhaust gas flows into the component 36 through the inlet pipe 46, expands and slows down as the gas travels through inlet cone 44, passes through the exhaust gas treatment element 42, then contracts and passes through the outlet cone 48 before exiting into the outlet pipe 50. The neck 54 connects the internal acoustic volume 52 in parallel with the flow through the component 36 to provide the Helmholtz resonator.

The exhaust gas pressure pulsations from the engine 12 travel down through the exhaust system 10 and are modified as they travel through the mechanisms of restriction, reflection, and absorption. When the pulsations reach the location of the flexible neck 54 they cause the exhaust gas in the resonator neck/connection to start moving. For low frequencies this gas can be considered as a lumped mass. The lumped mass of gas in the resonator neck 54 compresses or rarifies the exhaust gas in the internal acoustic volume 52. As the lumped mass of gas compresses this volume 52, the volume pressure increases. As the lumped mass of gas rarifies, the volume pressure decreases. The result of this pressure is to push the lumped mass in the opposite direction to which it is travelling. In this way, the engine sub-frame volume 52 is acting as a spring and provides a spring-mass system with a tuned frequency. As there is no net flow through the Helmholtz resonator in parallel with the exhaust system, and as the resonator neck 54 comprises a side-branch arrangement, the impact on back pressure is negligible.

FIG. 4 shows an example configuration where the vehicle frame member 30 comprises a support beam 70 that extends between vehicle side frame members 72. In this example, the acoustic volume 52 is sealed within an internal cavity of the support beam 70. The volume 52 is connected to the hot end 14 of the exhaust system via the neck 54. Optionally, or in addition to, the volume 52 could be located within a sealed internal cavity of the side frame members 72.

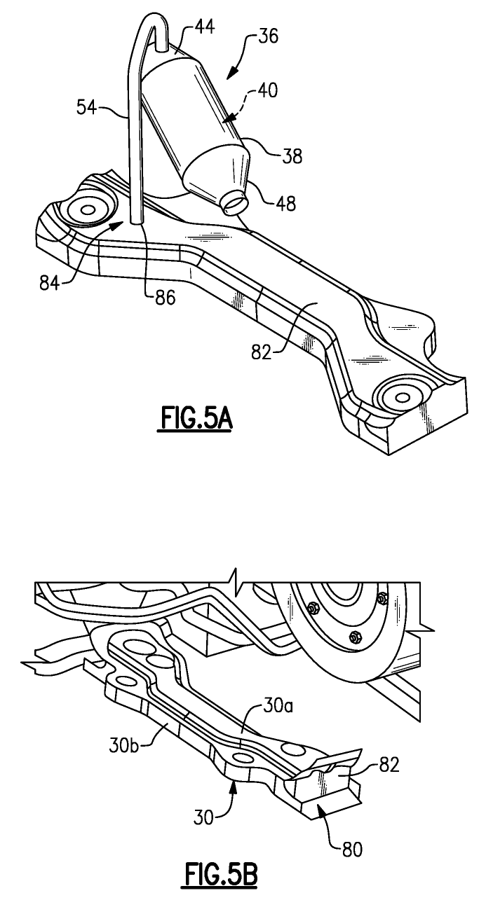

In each of these example configurations, the hollow cavity that defines the internal acoustic volume 52 is completely sealed and airtight. The subject invention provides a method for achieving this sealed volume. In one example, the method of forming the acoustic volume includes providing the vehicle frame member 30 with a hollow cavity 80 as shown in FIGS. 5A-B. An internal shell 82 is formed that is completely sealed and which includes at least one connection point 84. The internal shell 82 is located within the hollow cavity 80 and at least one exhaust system component, e.g. a hot end component 36, is connected to the internal shell 82 at the connection point 84 to provide at least one acoustic volume.

In one example, the internal shell 82 is formed by a blow molding process and the connection point 84 comprises at least one opening 86 resulting from the blow molding process. In one example, the internal shell 92 is formed from a plastic or composite material.

In one example, the vehicle frame member 30 is provided as at least first 30a and second 30b outer shells that enclose the hollow cavity 80. In one example method, the first 30a and second 30b outer shells are attached to each other to define a space for the hollow cavity 80. Next, the internal shell 82 is formed by blow molding material directly into the hollow cavity 80 to form the internal shell 82 after the frame has been assembled. One advantage with this configuration is that the internal volume is defined by the inner surfaces of the frame shells to maximize the volume and to ensure that the volume is completely leak-free.

In another example, the vehicle frame member 30 is provided as at least first 30a and second 30b outer shells that enclose the hollow cavity 80 and the internal shell 82 is formed prior to attaching the first 30a and second 30b outer shells to each other. One advantage with this configuration is that a plurality of internal shells 82 can be formed for various shapes/sizes and then a desired shape/size can be selected at a vehicle assembly location for incorporation into the frame.

Another example method includes providing the vehicle frame member 30 as a solid structure. The solid structure is then modified by machining, for example, to form one or more hollow cavities 80. The cavity 80 should be formed to be a shape/size that is not detrimental to the overall structural integrity of the frame member. An internal shell 82 can then be blow molded or inserted into each cavity 80 to form the one or more acoustic volumes. One advantage with this configuration is that an existing component can be modified without requiring a new frame member to be installed.

In another example, the vehicle frame member is comprised of a composite material with an internal hollow cavity that forms the acoustic volume. This hollow cavity can then be connected in parallel to the exhaust system component to form a parallel acoustic volume. Optionally, this composite vehicle frame member can be surrounded by a protective cover to prevent damage and/or puncture of the frame member into the hollow cavity. In one example, this protective cover can comprise metal stampings as discussed above that are placed around the composite material, which would then form an inner shell.

In one optional example, instead of forming a single acoustic volume in the frame member 30, a plurality of acoustic volumes can be formed in the vehicle frame member 30. Each acoustic volume could have a corresponding internal shell 82 that would be received within the hollow cavity 80 of the frame member 30.

As such, a leak-free volume is ensured within a space formed between frame outer shells of an engine sub-frame, cradle, or vehicle frame structure by using a plastic or composite internal shell that is received within such space. The internal shell can be blow molded into the space between the frame outer shells which ensures the leak-free volume because the only entrance to the internal volume is via the injection point. Additional advantages with this is that the internal shell is then being protected by the structure of the frame outer shells themselves. The opening or hole left by the blow molding process can then be used to form the connection location for the neck 54 which connects the volume of the internal shell 82 to the rest of the vehicle exhaust system.

The subject invention combines a tuning element with the primary function of acoustic attenuation with a component in the hot end 14 of the exhaust system 10 at a location that is much closer to the pressure anti-node at the engine exhaust outlet than traditional configurations. This provides improved acoustic efficiency with negligible back pressure impact resulting in tailpipe noise/acoustic volume improvement. Further, by including an acoustic volume within the already existing engine sub-frame structure, packaging problems are significantly reduced.

Although an embodiment of this invention has been disclosed, a worker of ordinary skill in this art would recognize that certain modifications would come within the scope of this invention. For that reason, the following claims should be studied to determine the true scope and content of this invention.

1. A method of forming an acoustic volume in a vehicle component comprising:
providing a vehicle frame member that includes a hollow cavity;
forming an internal shell that is completely sealed and which includes at least one connection point;
locating the internal shell within the hollow cavity; and
connecting at least one exhaust system component to the internal shell at the connection point to provide at least one acoustic volume.

2. The method according to claim 1 including forming the internal shell by blow molding.

3. The method according to claim 2 wherein the internal shell is formed from a plastic or composite material.

4. The method according to claim 2 wherein the connection point comprises at least one opening resulting from a blow molding process.

5. The method according to claim 2 including providing the vehicle frame member as at least first and second outer shells that enclose the hollow cavity, attaching the first and second outer shells to each other, and blowing molding material into the hollow cavity to form the internal shell.

6. The method according to claim 1 including providing the vehicle frame member as at least first and second outer shells that enclose the hollow cavity and forming the internal shell prior to attaching the first and second outer shells to each other.

7. The method according to claim 1 including forming a plurality of acoustic volumes in the vehicle frame member, wherein each acoustic volume has a corresponding internal shell.

8. The method according to claim 1 wherein the vehicle frame member comprises an engine sub-frame that is configured to at least partially support an engine.

9. The method according to claim 1 wherein the vehicle frame member comprises a structural side-support beam and/or cross-support beam extending between side-support beams.

10. The method according to claim 1 wherein the vehicle frame member comprises a solid structure and including modifying the vehicle frame member to form the hollow cavity.

11. The method according to claim 1 wherein the at least one exhaust component comprises an upstream portion of a vehicle exhaust system and including providing a pipe that connects the acoustic volume in parallel to the upstream portion of the vehicle exhaust system.

12. The method according to claim 11 including providing a first component that receives exhaust gas output from an engine and fluidly coupling a second component to the first component to define the upstream portion of the vehicle exhaust system.

13. The method according to claim 12 wherein the first component comprises an exhaust manifold or turbocharger, and wherein the second component comprises a catalytic converter.

14. The vehicle exhaust system according to claim 1 wherein the acoustic volume comprises a parallel volume connected to the exhaust system component.

15. A vehicle exhaust system comprising:
a first component that receives exhaust gas output from an engine;
a first exhaust assembly fluidly coupled to the first component to define a hot end of a vehicle exhaust system;
a second exhaust assembly fluidly coupled to the first exhaust assembly to define a cold end of the vehicle exhaust system, wherein an exhaust gas temperature at the hot end is higher than at the cold end;
a frame member that includes a hollow cavity;
an internal shell that is completely sealed and includes at least one connection point, wherein the internal shell is received within the hollow cavity to provide an internal acoustic volume; and
a neck that connects to the connection point of the internal shell such that the internal acoustic volume is in parallel to the hot end of the vehicle exhaust system.

16. The vehicle exhaust system according to claim 15 wherein the internal shell comprises a plastic or composite material.

17. The vehicle exhaust system according to claim 15 wherein the frame member comprises a support beam configured to at least partially support the engine and that connects to at least one additional vehicle frame member.

18. The vehicle exhaust system according to claim 15 wherein the frame member comprises at least first and second outer shells that enclose the hollow cavity.

19. A method of forming an acoustic volume in a vehicle component comprising:
providing a vehicle frame member comprised of a composite material that includes a hollow cavity; and
connecting at least one exhaust system component to the hollow cavity to provide at least one acoustic volume that is in parallel to the exhaust system component.

20. The method according to claim 19 wherein the vehicle frame member comprises an internal shell comprised of the composite material, the internal shell being completely sealed and including a at least one connection point, and including
connecting the exhaust system component to the internal shell at the connection point to provide at least one acoustic volume, and
surrounding the internal shell with a protective cover.
